(19) United States
(12) Patent Application Publication
(10) Pub. No.: US 2016/0339806 A1
(43) Pub. Date: Nov. 24, 2016

(54) CUSHION LENGTH ADJUSTER AND VEHICLE SEAT WITH CUSHION LENGTH ADJUSTER

(71) Applicant: Johnson Controls Technology Company, Plymouth, MI (US)

(72) Inventor: Horatiu M. POPESCU, Plymouth, MI (US)

(21) Appl. No.: 15/157,980

(22) Filed: May 18, 2016

Related U.S. Application Data
(60) Provisional application No. 62/165,583, filed on May 22, 2015.

(51) Int. Cl. B60N 2/02

(52) U.S. Cl. CPC B60N 2/0284

(57) ABSTRACT

A cushion has provisions for a support (3), to attach a gear box (5), and an other support (2) to attach a rail (11), on which a slider (12) travels back and forth. The slider (12) is pushed along the rail (11) by a lead screw (7) actuated by a worm gear/nut (6), rotated by a worm (10). The worm gear/gear nut (6) and the worm (10) are part of the gear box (5). The worm (10) has a kinematic couple (8) connecting to a motor (9), which is the original source of power in the system. The slider (12) is coated with a nylon skate (14), and is provided with a rotating joint B, which accommodates one end of the link (13). The other end of the link(13) is attached to a paddle (1) through an other rotation joint C. When the motor (9) rotates the worm (10), the worm gear/nut (6) rotates and pushes the lead screw (7) forward together with the slide (12), along the rails (11). The lower joint B of the link (13) is pushed forward and th upper joint C of the link will push the paddle (1) up, rotating it relative to joint A, and subsequently extending the cushion.

### CROSS REFERENCE TO RELATED APPLICATIONS

This application claims the benefit of priority under 35 U.S.C. §119 of U.S. Provisional Application 62/165,583 filed May 22, 2015, the entire contents of which are incorporated herein by reference.

### FIELD OF THE INVENTION

The present invention relates to vehicle seats in general and more particularly relates to a cushion length adjuster and to a vehicle seat having such a cushion length adjuster.

### BACKGROUND OF THE INVENTION

Vehicle seats are provided with cushions (also known as a seat part or seat base) that are most typically fixed with regard to a cushion length (distance from the edge near the backrest connection to a front edge, such as in a length dimension in a direction of vehicle travel). Vehicle seats have been provided with cushion length adjusters which allow an adjustment of the cushion length. However, such cushion length adjusters add a great deal of mass to the overall vehicle seat. Further, such cushion length adjusters may be provided with motors, for actuating a changeover in the cushion length between an initial length and an extended cushion length, wherein the motor/drive/transmission generates unwanted and excessive noise.

### SUMMARY OF THE INVENTION

It is an object of the invention to provide a cushion length adjuster and vehicle seat with cushion length adjuster wherein the mass of the cushion length adjuster is lowered and the arrangement and the kinematics of the arrangement generate less noise during operation then known structures.

According to the invention, a cushion length adjuster is provided comprising a cushion element, namely a cushion pan with a cushion pivot joint. A cushion extension element, in particular a paddle, is articulated to the cushion pan at the cushion pivot joint and is pivotable between a paddle extended position and a paddle retracted position. An adjuster rotational drive cooperates with a slider that moves along a slider guideway. A transmission connects the adjuster rotational drive with the slider for moving the slider along the slider guideway. A direction of motion of the slider adjuster rotational drive determines a direction of movement of the slider along the slider guideway. A link or link arrangement is articulated to the paddle at a paddle pivot joint and is articulated to the slider at a slider pivot joint. The rotation of the adjuster rotational drive moves the paddle between the paddle extended position and the paddle retracted position.

The adjuster rotational drive may include a motor. The motor may cooperate with a drive shaft mounted for rotation.

The transmission may include a lead screw connected to the slider. The lead screw may have external threading. A worm gear/nut having internal threading may be supported axially relative to the cushion element for moving the lead screw axially upon rotation of the worm gear/nut. The transmission may further include a worm connected to the drive, whereby a rotation of the worm causes the worm gear/nut to rotate.

The transmission may further comprise a gear box fixed to the cushion element. The gear box may support each of the worm gear/nut and the worm. A support element may support the gear box and connect the gear box to the cushion element.

The adjuster rotational drive may comprise a motor supported by the support element and a kinematic couple operatively connecting the motor to the worm of the transmission. The motor and the kinematic couple may be supported by the support element.

The support element may comprise a rail defining the slider guideway. The support element may comprise a first attachment point connecting the support element to the cushion element and a second attachment point connecting the support element to the cushion element.

According to a further aspect of the invention, a vehicle seat is provided comprising a cushion and a backrest and a cushion length adjuster. The cushion length adjuster is comprised of a cushion element of the cushion, namely a cushion pan with a cushion pivot joint. A cushion extension element, in particular a paddle, is articulated to the cushion pan at the cushion pivot joint and is pivotable between a paddle extended position and a paddle retracted position. An adjuster rotational drive cooperates with a slider that moves along a slider guideway. A transmission connects the adjuster rotational drive with the slider for moving the slider along the slider guideway. A direction of motion of the slider adjuster rotational drive determines a direction of movement of the slider along the slider guideway. A link is articulated to the paddle at a paddle pivot joint and is articulated to the slider at a slider pivot joint. The rotation of the adjuster rotational drive moves the paddle between the paddle extended position and the paddle retracted position.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of the cushion length adjuster according to the invention;

FIG. 2 is a perspective partially cutaway view of an embodiment of a cushion length adjuster according to the invention showing a part of a vehicle seat cushion extension part (paddle) that is covered in broken line;

FIG. 3 is a side partially cutaway view of the cushion length adjuster of FIG. 2, shown in a full down position and indicating sectional views IV-IV, V-V and VI-VI;

FIG. 4 is a sectional view taken along line IV-IV of FIG. 3;

FIG. 5 is a sectional view taken along line V-V of FIG. 3;

FIG. 6 is a sectional view taken along line VI-VI of FIG. 3;

FIG. 7 is a side partially cutaway view according to FIG. 3 but indicating sectional view VII-VII;

FIG. 8 is a sectional view taken along line VII-VII of FIG. 7;

FIG. 9 is a side partially cutaway view of the cushion length adjuster of FIG. 2, shown in the full up position;

FIG. 10A is a schematic side view of a vehicle seat according to the invention, with parts of the cushion length adjuster not shown, showing the vehicle seat cushion extension part (paddle) in the down position; and

FIG. 10B is a schematic side view of the vehicle seat of FIG. 10A, showing the vehicle seat cushion extension part (paddle) in the up position.

### DESCRIPTION OF THE PREFERRED EMBODIMENTS

Referring to the drawings, FIG. 1 schematically shows a range of features and kinematics according to one embodiment of a cushion length adjuster 30 according to the invention. A cushion extension part (paddle) 1 is articulated to a cushion part (cushion pan) 4, through a pivoting joint A. A support 3, attaches a gear box 5 to the cushion pan 4. Another support 2 attaches a rail (slider guideway) 11 to the cushion pan 4. On the rail 11, a slider 12 travels back and forth. The slider 12 is pushed or pulled along the rail 11 by a lead screw 7 actuated by a worm gear/nut 6, rotated by a worm 10. The worm/gear nut 6 and the worm gear or worm 10 are mounted to, and are a part of, the gear box 5. The gearbox 5 may include bearing mounts cooperating with bearing parts of the worm/gear nut 6 and cooperating with bearing parts of the worm 10. The worm 10 has a kinematic couple 8 connecting to a motor 9. The motor 9 is the original source of power drive in the system. The slider 12 is coated with a nylon skate 14 (FIG. 11), and is provided with a rotating joint B, which accommodates one end of a link 13. The other end of the link 13 is attached to the paddle 1 through another rotation joint C. Each of the pickup locations or joints A, B, C, may provide connections based on bearing joint connections 20, 22 and 24.

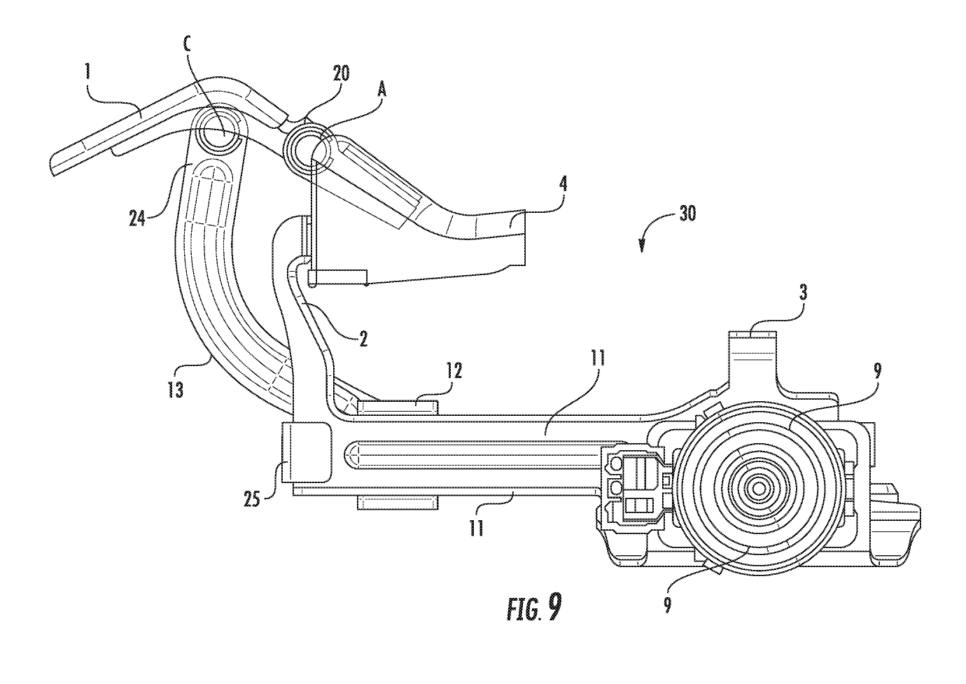

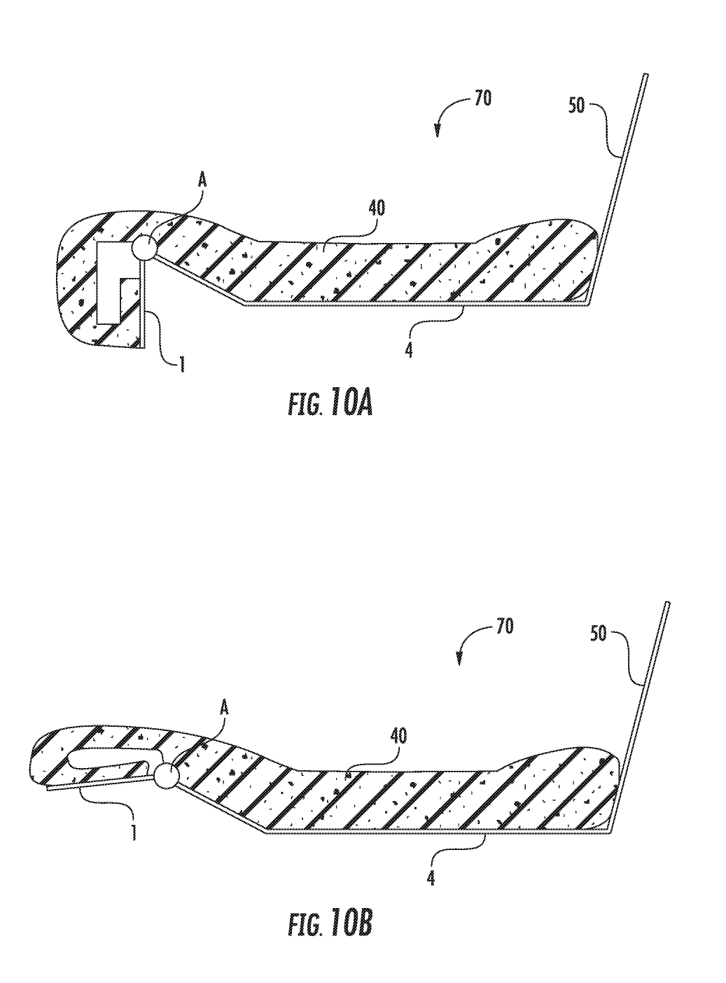

For moving the paddle 1 from the full down position to the up position, the motor is rotated in a direction for moving the lead screw 7 forward. When the motor 9 rotates the worm 10, the worm gear/nut 6 rotates and pushes the lead screw 7 axially together with the slide 12, along the rails 11. The lower joint B of the link 13 is pushed forward and the upper joint C of the link 13 will push the paddle 1 up, rotating the paddle 1 relative to joint A, and subsequently extending the cushion length based on the combination of cushion pan 4 and paddle 1 (see FIGS. 9 and 10B). When the motor 9 rotates the worm 10 in the opposite direction, the slide 12 moves backward and the link 13 will push the paddle 1 down, rotating the paddle 1 relative to joint A.

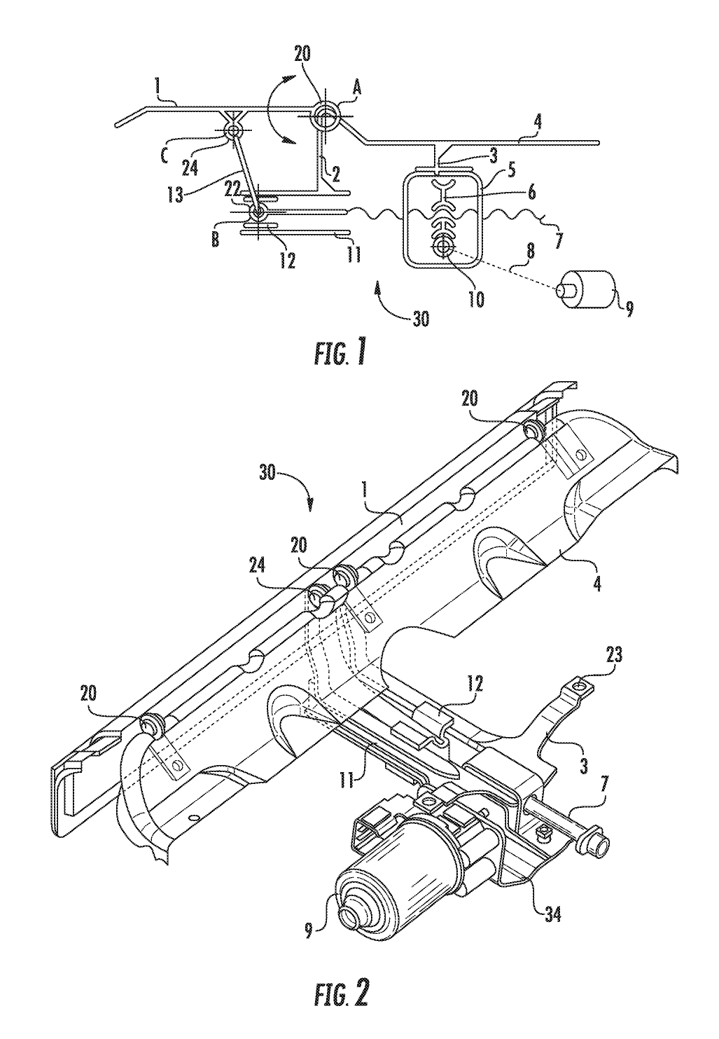

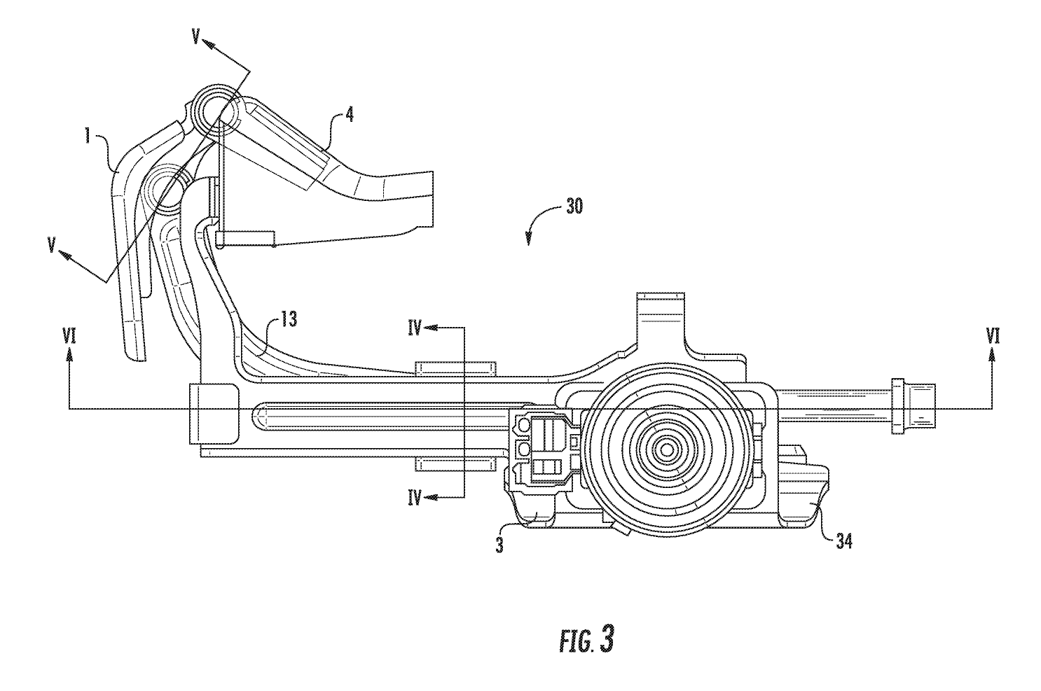

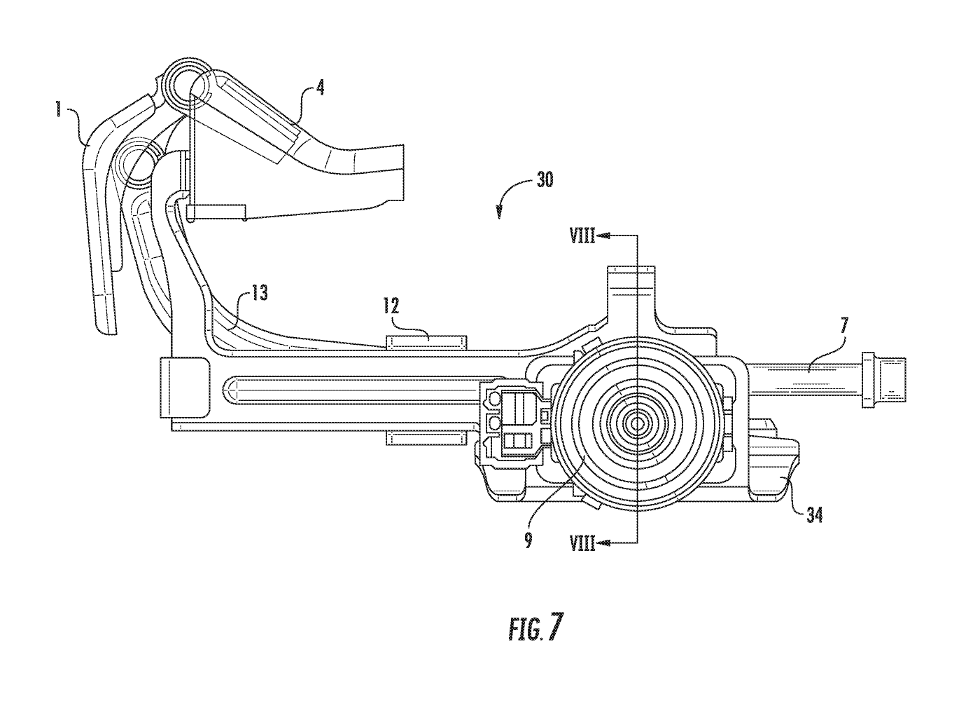

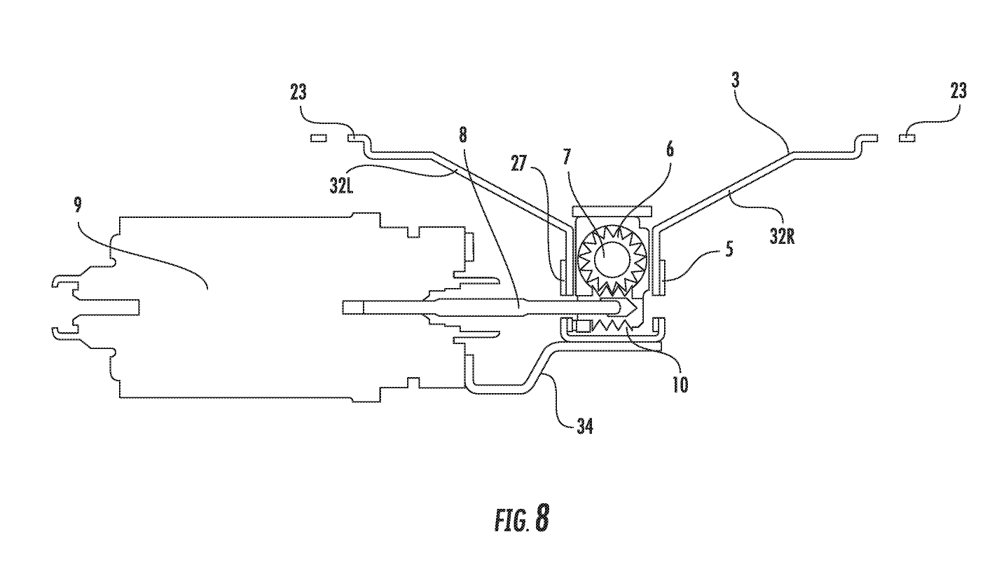

FIG. 2 shows a perspective view of a cushion length adjuster 30 with the paddle 1 articulated to the cushion pan 4, which is shown partially cutaway. The support 3 is formed from two similar parts 32R, 32L which also form the rail 11 and the other support 2 (see FIG. 7). The two parts 32R, 32L are joined by an end piece 25 and by a portion or a support portion 27 of the gearbox 5 (see FIGS. 6 and 8). The two parts of the rail 11 provide a central track or channel that receives the slider 12. The slider 12 has two slider parts that each have upper and lower flange parts which engage rail surfaces. As shown in FIG. 4, the rail facing surfaces of the slider 12 has a reduced friction surface that comprises a lining in the form of the nylon skate 14. The reduced friction surface may on the surface of the rail 11. The slider 12 and the rail 11 may also have cooperating reduced friction arrangement formed with ball bearings or another similar reduced friction bearing arrangement. The slider 12 supports the bearing joint 22 that provides a pivot connection with link 13.

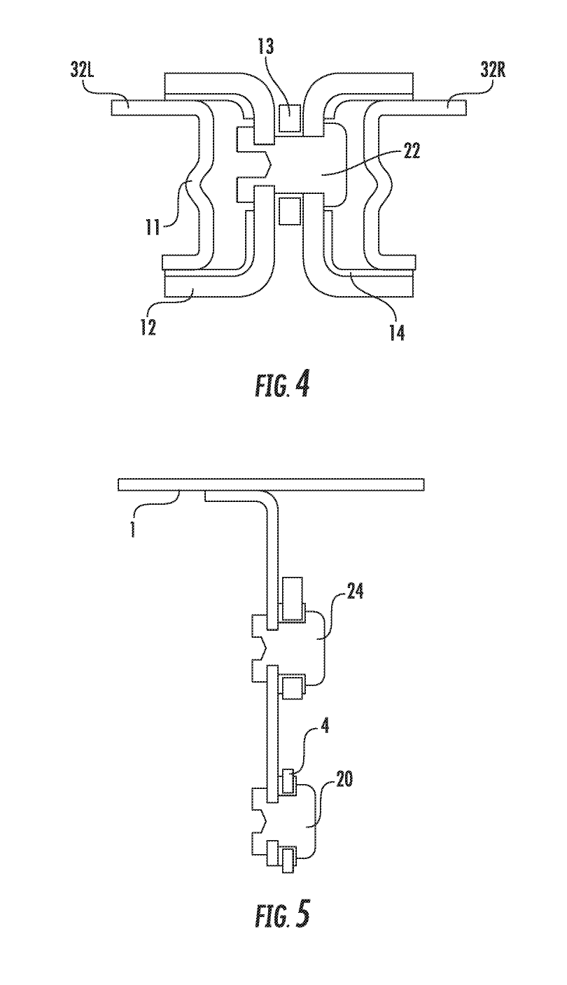

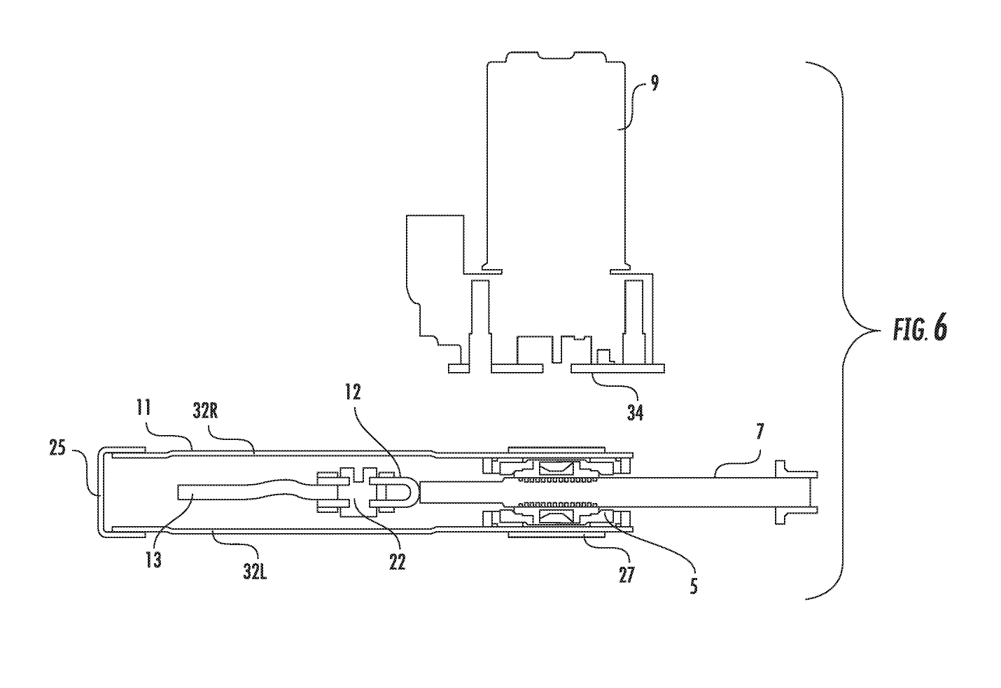

As can be seen in FIGS. 3 and 7, in the fold-down position the slider 12 is closest to the gearbox 5. In the fold-down position, the lead screw 7 extends in a rearward direction. The three pivots A, B and C, provided by bearings 20, 22 and 24, allow the link 13 to move the paddle 1 toward the up position, as the slider 12 is moved forward along the track 11. A compact and low mass arrangement is provided by driving the linear track arrangement, with a rotary motor 9.

The rotary motor 9 is supported by a bracket 34 (see FIG. 8) connected to the gearbox arrangement 5 and connected to the supports 2, 3 and rail 11. The gear box 5 supports the worm gear/nut 6, as shown in FIG. 6. The gearbox 5 and the worm gear/nut 6 support lead screw 7. The gear box 5 also supports the worm 10. As shown in FIG. 8, the worm 10 is connected to the kinematic couple 8 in the form of a drive shaft.

The motor 9 and the drive shaft 8 form an adjuster rotational drive. The gearbox 5, the worm gear/nut 6, the lead screw 7 and the worm 10 from a transmission, connecting the adjuster rotational drive with the slider 12, for moving the slider 12 along the slider guideway 11. In this embodiment the transmission 5, 6, 7, 10 converts a rotational drive of the motor 9 to a linear slider motion. The rotational output, of drive shaft 8, is also at a right angle to a direction of slider motion. The motor 9 may be driven in each of the two rotational directions, for moving the slider 12 forward and backward along the track 11.

FIG. 2 and FIG. 8 particularly show the two attachment points of the support 3, providing connection openings 23 for fixing the cushion length adjuster 30 to the lower side of the cushion pan 4 with bolts (not shown). As can be seen in FIG. 9, the support 2 connects the front end of the rail 11 of the cushion length adjuster 30 to the cushion pan 4. The supports 2, 3, the rail 11 and the support and gear box region 5 are provided by a robust structural arrangement, including the right and left side parts 32R and 32L cooperating with the end piece 25, and the gearbox support part 27 and gear box 5 (FIG. 6). The end piece 25 and the gearbox support part 27 may be welded or otherwise fixed to the right and left side parts 32R and 32L. The motor bracket 34 may be welded or otherwise fixed to the gearbox support part 27. The resulting structure is light weight and is fully supported by the vehicle seat, namely fully supported by the connections 2 and 3 to the cushion pan 4.

FIG. 10A schematically shows a vehicle seat 70 according to the invention, including seat part 4 and paddle 1, but omitting features of the adjuster 30. The vehicle seat 70 also includes a backrest 50. The vehicle seat 70 includes foam 40 that is positioned above the seat part 4 and contacts a surface of the paddle 1. The foam 40 wraps around the pivot A in the fold-down position as shown in FIG. 10 A. FIG. 10 B shows the vehicle seat 70 in the up position.

While specific embodiments of the invention have been shown and described in detail to illustrate the application of the principles of the invention, it will be understood that the invention may be embodied otherwise without departing from such principles.

What is claimed is:

1. A cushion length adjuster comprising:
a cushion element with a cushion pivot joint;
a cushion extension part articulated to the cushion at the cushion pivot joint and pivotable between a cushion extension part extended position and a cushion extension part retracted position;
an adjuster rotational drive;
a slider guideway fixed to the cushion element;
a slider for movement along the slider guideway;
a transmission connecting the adjuster rotational drive with the slider for moving the slider along the slider guideway, the direction of motion of the slider adjuster rotational drive determining a direction of movement of the slider along the slider guideway; and
a link articulated to the cushion extension part at a cushion extension part pivot joint and articulated to the slider at a slider pivot joint, whereby rotation of the adjuster rotational drive moves the cushion extension part between the cushion extension part extended position and the cushion extension part retracted position.

2. A cushion length adjuster according to claim 1, wherein the adjuster rotational drive comprises a motor.

3. A cushion length adjuster according to claim 1, wherein the transmission comprises
a lead screw connected to the slider, the lead screw comprising external threading;
a worm gear/nut, the worm gear/nut having internal threading and being supported axially relative to the cushion element for moving the lead screw axially upon rotation of the worm gear/nut; and
a worm connected to the drive, whereby a rotation of the worm causes the worm gear/nut to rotate.

4. A cushion length adjuster according to claim 3, wherein the transmission further comprises a gear box fixed to the cushion element, the gear box supporting each of the worm gear/nut and the worm.

5. A cushion length adjuster according to claim 4, wherein a support element supports the gear box and connects the gear box to the cushion element.

6. A cushion length adjuster according to claim 5 wherein the adjuster rotational drive comprises a motor supported by the support element and a kinematic couple operatively connecting the motor to the worm of the transmission, the motor and the kinematic couple being supported by the support element.

7. A cushion length adjuster according to claim 6 wherein the support element comprises a rail defining the slider guideway.

8. A cushion length adjuster according to claim 7, wherein the support element comprises a first attachment point connecting the support element to the cushion element and a second attachment point connecting the support element to the cushion element.

9. A cushion length adjuster according to claim 1, wherein at least one of the slider guideway and the slider cooperate to form a reduced friction bearing arrangement.

10. A cushion length adjuster according to claim 9, wherein the reduced friction bearing arrangement comprises a nylon skate at one of the slider guideway and the slider engaging a surface of the other of the slider guideway and the slider.

11. A vehicle seat comprising:
a seat base;
a seat backrest; and
a cushion length adjuster comprising:
a cushion element with a cushion pivot joint;
a cushion extension part articulated to the cushion at the cushion pivot joint and pivotable between a cushion extension part extended position and a cushion extension part retracted position;
an adjuster rotational drive;
a slider guideway fixed to the cushion element;
a slider for movement along the slider guideway;
a transmission connecting the adjuster rotational drive with the slider for moving the slider along the slider guideway, the direction of motion of the slider adjuster rotational drive determining a direction of movement of the slider along the slider guideway; and
a link articulated to the cushion extension part at a cushion extension part pivot joint and articulated to the slider at a slider pivot joint, whereby rotation of the adjuster rotational drive moves the cushion extension part between the cushion extension part extended position and the cushion extension part retracted position.

12. A vehicle seat according to claim 11, wherein the adjuster rotational drive comprises a motor.

13. A vehicle seat according to claim 11, wherein the transmission comprises
a lead screw connected to the slider, the lead screw comprising external threading;
a worm gear/nut, the worm gear/nut having internal threading and being supported axially relative to the cushion element for moving the lead screw axially upon rotation of the worm gear/nut; and
a worm connected to the drive, whereby a rotation of the worm causes the worm gear/nut to rotate.

14. A vehicle seat according to claim 13, wherein the transmission further comprises a gear box fixed to the cushion element, the gear box supporting each of the worm gear/nut and the worm.

15. A vehicle seat according to claim 14, wherein a support element supports the gear box and connects the gear box to the cushion element.

16. A vehicle seat according to claim 15 wherein the adjuster rotational drive comprises a motor supported by the support element and a kinematic couple operatively connecting the motor to the worm of the transmission, the motor and the kinematic couple being supported by the support element.

17. A vehicle seat according to claim 16 wherein the support element comprises a rail defining the slider guideway.

18. A vehicle seat according to claim 17, wherein the support element comprises a first attachment point connecting the support element to the cushion element and a second attachment point connecting the support element to the cushion element.

19. A vehicle seat according to claim 11, wherein at least one of the slider guideway and the slider cooperate to form a reduced friction bearing arrangement.

20. A vehicle seat according to claim 19, wherein the reduced friction bearing arrangement comprises a nylon skate at one of the slider guideway and the slider engaging a surface of the other of the slider guideway and the slider
